(19) United States
(12) Patent Application Publication
(10) Pub. No.: US 2001/0033402 A1
(43) Pub. Date: Oct. 25, 2001

(54) Switchable hologram and method of producing the same

(76) Inventor: Milan M. Popovich, Leicester (GB)

Correspondence Address: Eric A. Stephenson, SKJERVEN MORRILL MacPHERSON LLP, 25 Metro Drive, Suite 700, San Jose, CA, 95110-1349, US

(21) Appl. No.: 09/780,203

(22) Filed: Feb. 9, 2001

Related U.S. Application Data
(60) Provisional application No. 60/181,628, filed on Feb. 10, 2000.

(51) Int. Cl. G03H 1/02; G02B 5/32

(52) U.S. Cl. 359/24; 359/3; 359/7; 359/15

(57) ABSTRACT

Disclosed are a holographic optical element (HOE) and a method of producing the HOE. In one embodiment of the method, a substrate is provided which is capable of recording a hologram or diffraction gratings. This substrate is illuminated with a first pair of light beams and a second pair of light beams. The first pair of light beams intersect within the substrate. The second pair of light beams also intersect within the substrate. Additionally, the first pair of light beams intersect at a region within the substrate where the second pair of light beams intersect. Normally, each of the first pair of light beams comprises light of a first wavelength, and each of the second pair of light beams comprises light of a second wavelength, where the first wavelength is different from the second wavelength.

### RELATED APPLICATIONS

This application claims priority to U.S. Provisional Pat. application Ser. No. 60/181,628 filed Feb. 10, 2000.

### BACKGROUND OF THE INVENTION

Multicolor holographic optical elements (HOEs), whether static or dynamic, can be produced by stacking separate substrates. Each of these separate substrates records a single hologram or set of diffraction gratings that operate on a specific wavelength or wavelength band of incident light while passing or transmitting the remaining wavelengths of incident light with little or no diffraction. The individual substrates can be stacked together between a pair of electrodes to form an electrically switchable holographic optical element (ESHOE). FIG. 1a shows a cross section of an exemplary multicolor ESHOE 10 having three substrates 12R-12G positioned between a pair of light transparent electrodes 14 and a pair of light transparent and electrically non-conductive layers 16 (e.g., glass). The three substrates 12R-12G record holograms (i.e., a set of diffraction gratings) that diffract red, blue, and green wavelength light, respectively, when active. FIG. 1a shows ESHOE 10 operating in the active state with substrates 12R-12G concurrently diffracting red, blue, and green wavelength components, respectively, of incident light 20 to produce diffracted red, blue, and green wavelength output lights 22R-22G, respectively. It is noted that substrates 12R-12G are wavelength specific, e.g., substrate 12R diffracts red wavelength light when active while passing the remaining components of incident light 20 with no or little diffraction. Further, substrates 12R-12G operate on s or p-polarized components of incident light when active.

When voltage of a sufficient magnitude is applied to electrodes 14, an electric field is simultaneously created in substrates 12R-12G, and ESHOE 10 switches to the inactive mode. FIG. 1b shows the ESHOE of FIG. 1a operating in the inactive mode. In the inactive mode, all or substantially all of incident light 20 passes through ESHOE 10 with little or no diffraction.

### SUMMARY OF THE INVENTION

The present invention relates to HOEs and a method of producing the HOEs. The present invention finds application in both static and dynamic or switchable HOEs. In one embodiment of the method, a substrate is provided which is capable of recording a hologram or diffraction gratings. This substrate is illuminated with a first pair of light beams and a second pair of light beams. The first pair of light beams intersect within the substrate. The second pair of light beams also intersect within the substrate. Additionally, the first pair of light beams intersect at a region within the substrate where the second pair of light beams intersect. Normally, each of the first pair of light beams comprises light of a first wavelength, and each of the second pair of light beams comprises light of a second wavelength, where the first wavelength is different from the second wavelength.

In the embodiment where resulting HOE is switchable, the method further comprises placing the substrate between a pair of electrically conductive and light transparent layers. In this embodiment, the HOE operates between active and inactive states. In the active state, the HOE diffracts light of the first and second wavelengths. In the inactive state HOE transmits light of the first and second and wavelengths without substantial alteration.

Preferably, the HOE is produced with the substrate concurrently illuminated by the first and second pairs of light beams so that, for example, a point of the substrate is concurrently illuminated with all beams of the first and second pairs of light beams. Alternatively, the HOE could be produced with the substrate illuminated by the second pair of light beams after the first pair of light beams illuminates the substrate.

### BRIEF DESCRIPTION OF THE DRAWINGS

The present invention may be better understood, and it's numerous objects, features and advantages made apparent to those skilled in the art by referencing the accompanying drawings. The use of the same reference number throughout the figures designates a like or similar element.

FIG. 1a shows a cross-sectional view of a multicolor ESHOE operating in the active state;

FIG. 1b shows a cross-sectional view of the multicolor ESHOE of FIG. 1a operating in the inactive state

FIG. 2a shows a cross-sectional view of an ESHOE;

FIG. 2b illustrates operational aspects of recording a hologram within the ESHOE of FIG. 2a in accordance with one embodiment of the present invention;

FIG. 3 illustrates aspects of creating multiple light interference fringe patterns within the substrate of the ESHOE shown in FIG. 2b in accordance with one embodiment of the present invention;

FIG. 4 is a diagram illustrating light intensity distribution within the substrate of the ESHOE shown in FIG. 2a during the process of recording a hologram in accordance with one embodiment of the present invention; and

FIGS. 5a and 5b illustrate operational aspects of the ESHOE shown in FIG. 2a after the hologram is recorded therein in accordance with one embodiment of the present invention.

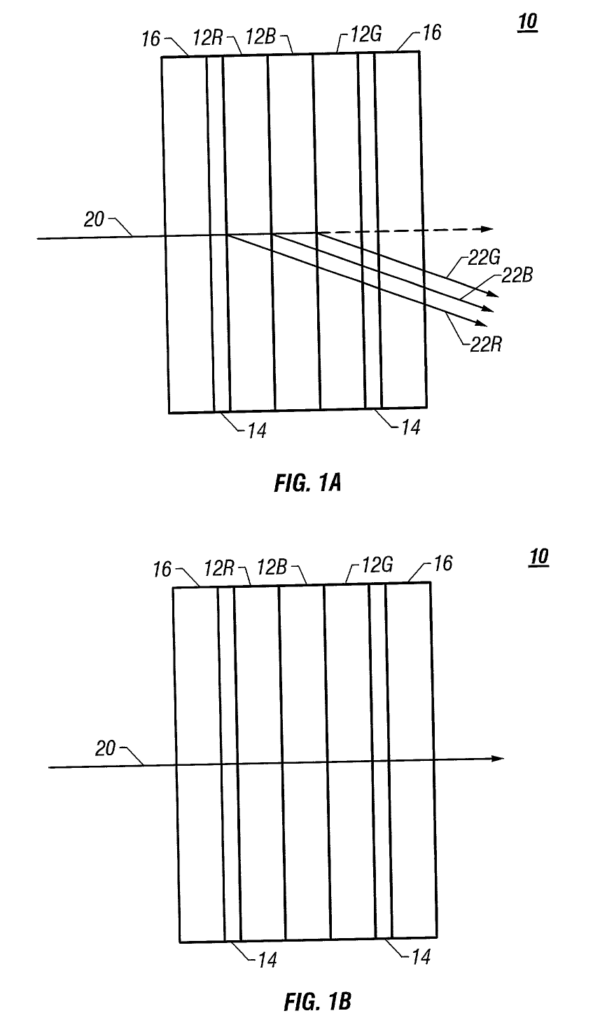

While the invention is susceptible to various modifications and alternative forms, specific embodiments thereof are shown by way of example in the drawings and will herein be described in detail, it should be understood, however, that the drawings and detailed description thereto are not intended to limit the invention to the particular form disclosed but on the contrary, the intention is to cover all modifications, equivalents, and alternatives falling within the spirit and scope of the present invention as defined by the appended claims.

### DETAILED DESCRIPTION

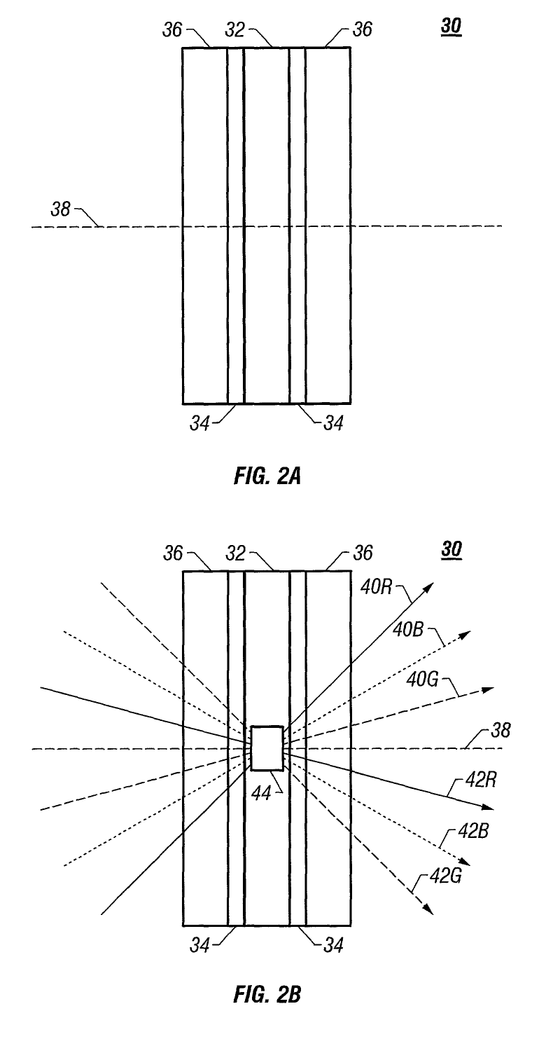

FIG. 2a shows a cross-sectional view of an ESHOE 30 before a hologram is recorded therein in accordance with the present invention. As will be more fully described below, the hologram recorded within the ESHOE 30 in accordance with the present invention is, in effect, a superimposition or combination of several holograms. The term superimposed hologram as used in this description is understood to mean a hologram which represents a superimposition or combination of separate holograms. The present invention will be described with reference to forming holograms within a substrate of an ESHOE, it being understood that the present invention may find application to forming superimposed holograms in substrates of static or non-switchable HOEs. The superimposed hologram recorded in ESHOE 30 may take form in a Bragg or volume hologram. Thin phase holograms are also contemplated.

ESHOE 30 includes a substrate layer 32 made of a material for recording holograms. Substrate 32 is sandwiched between a pair of substantially transparent and electrically conductive layers (e.g., electrodes) 34 and a pair of substantially transparent and electrically nonconductive layers 36. Layers 32-36 are aligned on a common optical axis 38.

In one embodiment, substrate 32, prior to hologram formation therein, is formed from a mixture of liquid crystal (LC) and monomer described in U.S. Pat. No. 5,942,157, issued to Sutherland et al. and incorporated herein by reference. Materials other than that described in U.S. Pat. No. 5,942,157 may be employed in the substrate of the present invention. The material described in U.S. Pat. No. 5,942,157 is preferred since its use results in ESHOEs having a relatively high diffraction efficiency, relatively fast switching between active and inactive states, low switching voltages, easier hologram recording and processing, etc. The substrate material could be extended to include materials that are individually responsive to the wavelengths of the red, blue, and green visible light. For example, additional components such as photo-initiators, and other monomers and liquid crystal components that have peak responses at red, blue and green wavelengths, could be added to the material described in U.S. Pat. No. 5,942,157.

In one embodiment, the substantially transparent and electrically nonconductive layers 36 may be formed from glass, plastic or other transparent materials. Layers 36 are shown to be flat. The present invention should not be limited thereto. Rather, Layers 36 may be curved with curved front and back surfaces. In this alternative embodiment, substrate 32 and electrodes 34 would likewise be curved to fit the curved shape of layers 36. Substantially transparent and electrically nonconductive layers 36 will hereinafter be referred to as glass layers 36 it being understood that layers 36 may be formed from other rigid or flexible materials. Substantially transparent and electrically conductive layers 34 may be formed from indium tin oxide (ITO). Alternatively, layers 34 may take form in conducting polymer. Substantially transparent and electrically conductive layers 34 will hereinafter be referred to as electrodes 34. In practice, electrodes 34 may be formed on respective glass layers 36 using, for example, a vapor deposition technique. It is noted that electronic circuitry for switching the ESHOE 30 between active and inactive modes, as more fully described below, may be formed on one or more of layers 34 using standard semiconductor processing techniques. Although not shown, an anti-reflection coating may be applied to selected surfaces of the layers of ESHOE 30, including surfaces glass layers 36 and electrodes 34, to improve the overall transmissive efficiency of ESHOE 30 and to reduce stray light.

Layers 32-36 may have substantially thin cross-sectional widths, thereby providing a substantially thin aggregate in cross section. More particularly, substrate layer 32 may have a cross-sectional width of 5-12 microns (the precise width depending on the spectral bandwidth and required diffraction efficiency) while layers 36 may have a cross-sectional width of 0.4-0.8 mm. Layers 36 could be formed from thin plastic foils of thickness less than 0.1 mm. Obviously, electrodes 34 must be substantially thin to be transparent. The aperture of the hologram recorded in substrate 32 could be as small as 5 mm on one side or 25 mm² in total surface area. The aperture could be larger for most conventional optical equipment.

In general, holograms are created in a substrate using a single pair of recording beams of light, i.e., a reference beam and an object beam. In contrast, the present invention creates a hologram in a single substrate using multiple pairs of recording beams. The term single substrate as used in this description is defined to mean a continuously formed holographic recording medium positioned between a pair of electrodes and/or a pair of glass layers.

FIG. 2b shows the ESHOE 30 of FIG. 2a illuminated by a first pair of recording beams 40R and 42R, a second pair of recording beams 40B and 42B, and a third pair of recording beams 40G and 42G. The present invention may be implemented with ESHOE 30 illuminated by two or more pairs of recording light beams. ESHOE 30 may be illuminated sequentially by the first, second, and third pairs or recording beams. In a preferred embodiment, ESHOE 30 is concurrently illuminated by the first, second, and third pairs of recording beams. The recording beams of light may be beams of coherent light, preferably laser beams. In principle, the recording beams could be consist of light from near-monchromatic sources or filtered broad sources, but such approaches are unlikely to give acceptable holograms. Each recording beam in a pair may result from a single laser beam which is subsequently split by conventional optics. Thus, the first, second, and third pairs of recording beams may originate from first, second, and third laser light sources, respectively.

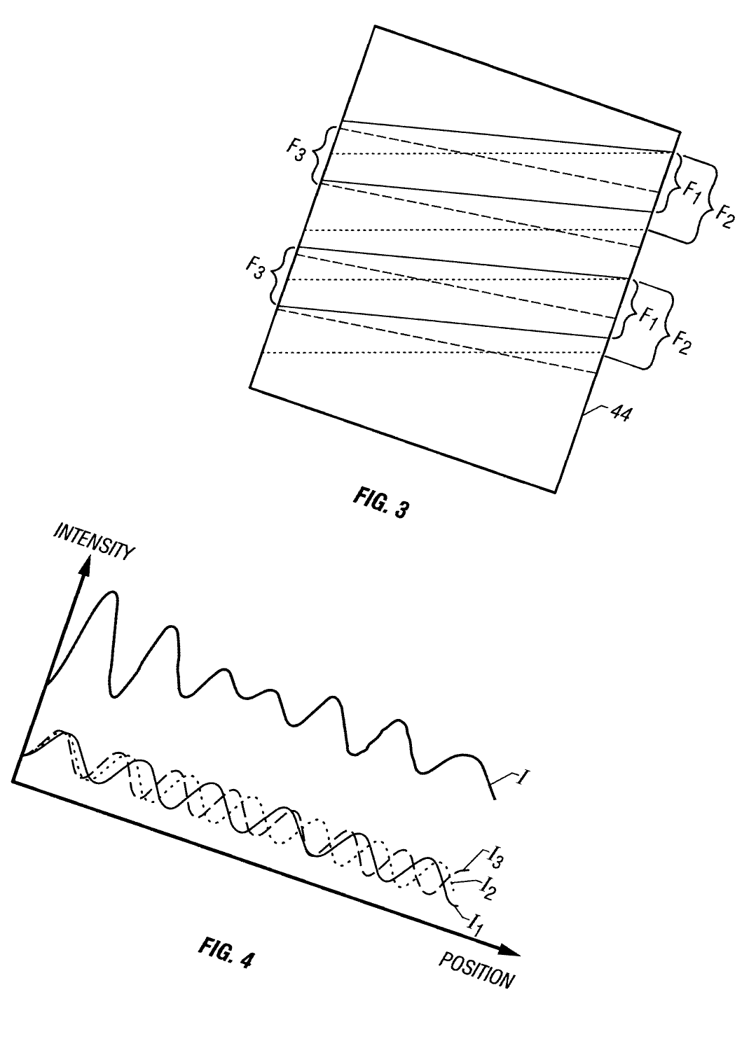

The hologram created by the first, second, and third pairs of recording beams can be seen as a superimposition or combination of separate first, second, and third holograms concurrently created within substrate 32. The first hologram may be created in response to the first pair of recording beams 40R and 42R interacting with each other to create a first light interference fringe pattern F1 (shown in solid lines in FIG. 3) within substrate 32. The first light interference fringe pattern is dependent on a phase difference between the two recording beams 40R and 42R. The first pair of light beams 40R and 42R may consist of light of a first wavelength or wavelength band, preferably in the red region of the visible spectrum. The first interference pattern is three-dimensional in nature.

The second hologram can be created in response to the second pair of recording beams 40B and 42B interacting with each other to create a second light interference fringe pattern F2 (shown in dotted lines in FIG. 3) within substrate 32. The second light interference pattern is dependent on the phase difference between the two recording beams 40B and 42B. The second pair of beams 40B and 42B may consist of light of a second wavelength or wavelength band that is different from the first wavelength or wavelength band of beams 40R and 42R. Preferably, the second pair of beams 40B and 42B consist of light within the blue region of the visible spectrum. The second interference pattern is three-dimensional in nature.

The third hologram can be created in response to the third pair of recording beams 40G and 42G interacting with each other to create a third light interference fringe pattern F3 (shown as broken lines in FIG. 3) within substrate 32. The third light interference pattern is dependent on the phase difference between the two recording beams 40G and 42G. The third pair of beams 40G and 42G may consist of light of a third wavelength or wavelength band that is different from the wavelengths or wavelength bands of beams 40R, 40B, 42R, and 42B. Preferably, the third pair of beams 40G and 42G consist of light within the green region of the visible spectrum. The third interference pattern is three-dimensional in nature.

If interference fringe patterns F1, F2, and F3 are created concurrently, F1, F2, and F3 in combination may form a superimposed or combined light interference fringe pattern F (not shown in the drawings). FIG. 4 shows how the intensity distributions of the interference fringe patterns F1-F3 may vary with position in substrate layer 30, with the intensity of F1 indicated by solid line I1, the intensity of F2 indicated by dotted line I2, and the intensity of F3 being indicated by broken line I3. The superimposition or combination of these intensity distributions gives rise to a combined or superimposed intensity distribution indicated by line I, which in this example, represents the overall intensity distribution of the combined or superimposed fringe pattern F. I and I1-I3 are measured along a direction lying in a plane within the substrate 30 perpendicular to the axis 38. It is noted that if substrate 32 is substantially small, the entire aperture of the substrate 32 can be concurrently illuminated by the first, second, and third pairs of recording beams thus creating the superimposed hologram in a single step. Alternatively, a small region (e.g., region 44) of the substrate 32 may be concurrently illuminated by the first, second, and third pairs of recording beams. In this alternative hologram recording process the first, second, and third pairs of recording beams may be stepped across the aperture of the substrate 32 in unison.

Interaction of recording beams within the substrate 32 causes photo-polymerization. More particularly, photo-polymerization is initiated in the regions of the substrate 32 where the light intensity of distribution I is relatively high. In these high intensity regions, monomers of the substrate material begin linking with one another to form polymer chains. The rate at which photo-polymerization occurs depends upon the light intensity. The monomers tend to diffuse into higher light intensity regions to link up with the rapidly forming polymer chains. Simultaneously, liquid crystal in the substrate material tends to diffuse into regions of the substrate where the intensity of the light distribution I is relatively low. These regions become saturated with the liquid crystal material, with the result that droplets of liquid crystal precipitate and grow in size as the diffusion process continues. Once the diffusion process has reached an appropriate stage, the substrate 32 is flooded with collimated, coherent light of uniform intensity. This causes regions of liquid crystal droplets to be completely surrounded and locked in by regions of polymer. The regions of liquid crystal droplets are clearly interspersed by regions of polymer to form a pattern that mimics the pattern of light intensity I shown in FIG. 4.

The creation of the superimposed hologram is described in terms of adding the distributions of light I1, I2, and I3 created by the first, second, and third pairs of recording beams, respectively. Each of the first, second, and third pairs of recording beams could individually create first, second, and third holograms, respectively according to I1, I2, and I3. Each of the first, second, and third holograms would have a distinct refractive index modulation. The superimposed hologram can be seen as a superimposition of the first, second, and third holograms, the superimposed hologram having a refractive index modulation that represents the combined effect of the first, second, and third refractive index modulations of the first, second, and third holograms, respectively.

The regions of liquid crystal droplets within the superimposed hologram are interspersed by regions of clear polymer to form diffraction gratings. The diameter of the liquid crystal droplets are typically within the range of 0.1 to 0.2 microns which is considerably less than the wavelength (0.4 microns to 0.7 microns) of the light of interest. As a result, clouds of droplets form homogeneous regions with an average refractive index that is slightly lower than that of the interspersed polymer regions. The resulting diffraction gratings can simulate a range of optical elements ranging from a relatively simple pattern that performs simple optical functions such as light beam deflection, to a complex pattern that corresponds to more complex optical functions such as lensing, where the hologram can replace a considerable number of refractive lenses. The diffraction gratings could also perform the functions of diffusion and filtering. The diffraction gratings could also provide a directly viewable holographic image (as in a conventional pictorial hologram). When a voltage is applied between electrodes 34, an electric field is established in substrate layer 32. This electric field causes the natural orientation of molecules inside the liquid crystal droplets to change, which causes the refractive index modulation of the diffraction gratings to reduce and the diffraction efficiency of the superimposed hologram to drop to very low levels, effectively erasing the superimposed hologram. The material used within substrate layer 32 result in diffraction gratings that switch at a high rate (e.g., the material may be switched in tens of microseconds, which is very fast when compared with conventional liquid crystal display materials) and a high diffraction efficiency.

FIG. 2b shows that the angle 44R between the first pair of beams 40R and 42R is equal to the angle between the second pair of beams 40B and 42B and the angle between the third pair of beams 40G and 42G. FIG. 2b also shows that the first, second, and third pairs of beams are angularly separated from each other. Moreover, FIG. 2b shows that the angle of separation between the first and second pairs of recording beams is equal to the angle of separation between the second and third pairs of recording beams. The present invention should not be limited thereto. In particular, the angle between the first pair of beams 40R and 42R may be different from either the angle between the second pair of beams 40B and 42B or the angle between the third pair of beams 40G and 42G. This may be true at any given point within the volume of substrate layer 20 where the three pairs of light beams interact. Moreover, angular separation between the first pair of beams and the second pair of beams may be different than the angular separation between the second pair of beams and the third pair of beams at a given point within a volume of substrate 32. Further, angular separations between the first, second, and third pairs of beams are shown as substantially large in FIG. 2b. In practice, the angular separations between the first, second, and third pairs of beams may be quite small.

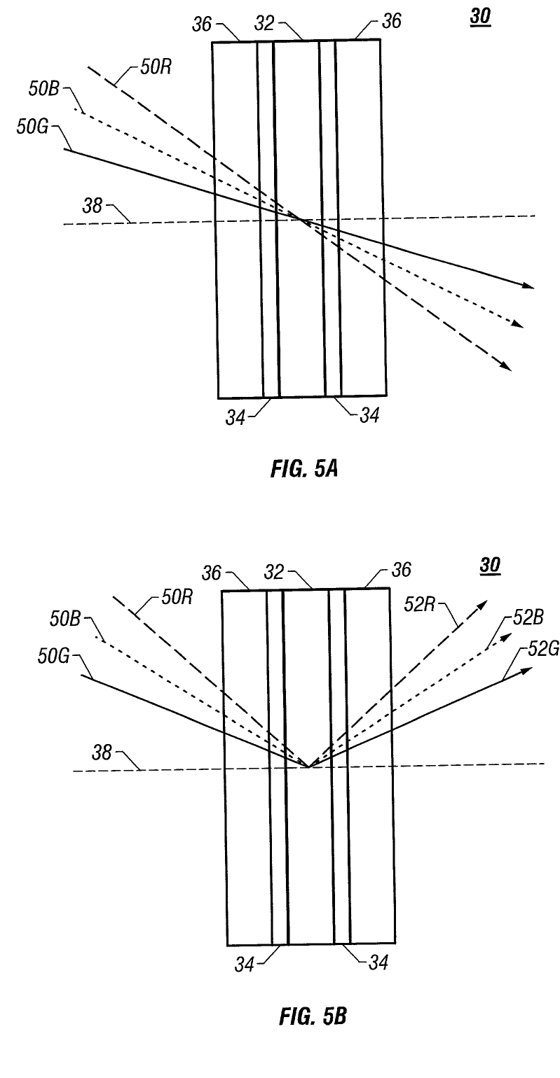

FIGS. 5a and 5b illustrates operational aspects of the ESHOE 30 shown in FIGS. 2a and 2b after the hologram recording process described above has completed. In one mode of operation, as shown in FIG. 4A, a voltage is applied to electrodes 34 thereby creating an electric field within substrate 32. ESHOE 30 concurrently receives three incident lights 50R, 50B, and 50G having wavelengths in the red, blue and green regions of the visible spectrum. With the electric field established in substrate 32, the superimposed hologram recorded therein is essentially erased so that incident lights 50R, 50B, and 50G pass through ESHOE 30 with little or no diffraction or alteration. FIG. 5b shows the same ESHOE 30 of FIG. 5b after the electric field within substrate 32 has been eliminated. In this mode, incident lights 50R, 50B, and 50G are diffracted within the volume of substrate 32 to produce diffracted output lights 52R, 52B, and 52G, respectively. Diffraction of incident lights 50R, 50B, and 50G may occur concurrently if ESHOE 30 concurrently receives incident lights 50R, 50B, and 50G, or diffraction of incident lights 50R, 50B, and 50G may occur sequentially if ESHOE 30 sequentially receives incident lights 50R, 50B, and 50G.

In FIG. 5b, incident beams 50R, 50B, and 50G have substantially the same wavelength or wavelength band as recording beams 40R, 40B, and 40G, respectively. Incident beams 50R, 50B, and 50G are received by ESHOE 30 at incidence angles substantially similar to the incidence angles of recording beams 40R, 40B, and 40G, respectively, measured with respect to axis 38. Moreover, incident beams 50R, 50B, and 50G are received by the ESHOE 30 at the same region where recording beams 40R-40G and 42R-42G were received. Under these conditions, according to the basic principals of Bragg hologram diffraction, diffracted output lights 52R-52G will emerge from the ESHOE 30 at exit angles which are substantially equal to the incidence angles of recording beams 42R-42G, respectively, measured with respect to axis 38. The difference in exit angles of diffracted beams 52R-52G can be made small enough that the human eye perceives no exit angle difference between diffracted beams 52R-52G when viewed at a short distance from the ESHOE 30. The effect of the difference in exit angles can be overcome in different ways depending on the application. If the viewing distance is short the three beams will have sufficient overlap in the region of the eye to provide color mixing. In many applications the invention will be used with additional viewing optics, whether conventional or holographic, that may include lenses, mirrors and diffusers, which could be used to combine and mix the three colors using techniques well known to those skilled in the art. FIG. 5b incident beams 50R-50G received by ESHOE 30 with unequal incidence angles. Incident beams 50R-50G may be received by ESHOE 30 with equal incidence angles. In this arrangement, the exit angles of the diffracted beams 52R-52G will not change substantially.

The ESHOE 32 shown in FIGS. 5a and 5b exhibit very high diffraction efficiencies, and switching between its active and inactive states can be achieved very rapidly, typically in less than 150 microseconds and perhaps, in only a few microseconds. The ESHOE 30 shown in FIGS. 5a and 5b may find application in a wide variety of optical systems including those described in: U.S. Pat. application Ser. No. 09/334,286 entitled Three Dimensional Projection Systems Based On Reconfigurable Holographic Optics filed Jun. 6, 1999; U.S. Pat. application Ser. No. 09/607,432 entitled Holographic Projection System filed Jun. 30, 1999; U.S. Pat. application Ser. No. 09/366,443 entitled Switchable Holographic Optical System filed Aug. 3, 1999; U.S. Pat. application Ser. No. 09/478,150 entitled Optical Filter Employing Holographic Optical Elements And Image Generating System Incorporating The Optical Filter filed Jan. 1, 2000; U.S. Pat. application Ser. No. 09/418,731 entitled Light Intensity Modulator Based On Electrically Switchable Holograms filed Oct. 15, 1999; U.S. Pat. application Ser. No. 09/533,608 entitled Illumination System Using Optical Feedback filed Mar. 23, 2000; U.S. Pat. application Ser. No. 09/439,129 entitled Apparatus For Viewing An Image filed Nov. 12, 1999; and U.S. Pat. application Ser. No. 09/533,120 entitled Method And Apparatus For Illuminating A Display filed Mar. 23, 2000.

Although the present invention have been described in connection with several embodiments, the invention is not intended to be limited to the specific forms set forth herein, but on the contrary, it is intended to cover such alternatives, modifications, and equivalents as can be reasonably included with in the spirit and scope of the invention as defined by the appended claims.

What is claimed is:

1. A method of making a holographic optical element, the method comprising:
providing a substrate for recording a hologram;
illuminating the substrate with a first pair of light beams, wherein the first pair of light beams intersect within the substrate;
illuminating the substrate with a second pair of light beams, wherein the second pair of light beams intersect within the substrate;
wherein the first pair of light beams intersect at a region within the substrate where the second pair of light beams intersect.

2. The method of claim 1 wherein each of the first pair of light beams comprises light of a first wavelength, and wherein each of the second pair of light beams comprises light of a second wavelength, wherein the first wavelength is different from the second wavelength.

3. The method of claim 1 wherein each of the first pair of light beams comprises light with wavelengths in a first bandwidth, and wherein each of the second pair of light beams comprises light with wavelengths in a second bandwidth, wherein the first bandwidth is different from the second bandwidth.

4. The method of claim 1 further comprising placing the substrate between a pair of electrically conductive, light transparent layers.

5. The method of claim 1 wherein each of the first and second pairs of light beams comprises coherent light.

6. The method of claim 1 wherein the region in the substrate is concurrently illuminated by the first and second pairs of light beams.

7. The method of claim 1 wherein the region in the substrate is illuminated by the second pair of light beams after the region is illuminated by the first pair of light beams.

8. The method of claim 1 wherein the substrate comprises oppositely facing front and back surfaces, wherein each of the beams of the first and second pair of beams defines an angle measured with respect to a line normal to the front surface, and wherein each of the angles is different from each other.

9. The method of claim 1 wherein the substrate comprises:
a monomer dipentaerythritol hydroxypentaacrylate;
a liquid crystal;
a cross-linking monomer;
a coinitiator; and
a photoinitiator dye.

10. The method of claim 1 wherein the substrate comprises before illumination by the first and second pairs of light beams:
a polymerizable monomer;
a liquid crystal;
a cross-linking monomer;
a coinitiator; and
a photoinitiator dye.

11. A holographic optical element (HOE) comprising a substrate with a hologram recorded therein, the hologram being formed by illuminating the substrate with first and second pairs of light beams, wherein the first pair of light beams intersect within the substrate, wherein the second pair of light beams intersect within the substrate, and wherein the first pair of light beams intersect at regions within the substrate where the second pair of light beams intersect.

12. The HOE of claim 11 further comprising a pair of electrically conductive, light transparent layers, wherein the substrate is positioned between the pair of electrically conductive, light transparent layers.

13. The HOE of claim 11 wherein each of the first pair of light beams comprises light of a first wavelength, wherein each of the second pair of light beams comprises light of a second wavelength, wherein the first wavelength is different from the second wavelength, wherein the HOE operates between the active and inactive states, wherein the HOE diffracts light of the first and second wavelengths when operating in the active state, and wherein the HOE transmits light of the first and second and wavelengths without substantial alteration when operating in the inactive state.

14. The HOE of claim 11 wherein each beam of the first and second pairs of light beams comprises coherent light.

15. The HOE of claim 11 wherein the first and second pairs of light beams concurrently illuminates the region in the substrate.

16. The HOE of claim 11 wherein the second pair of light beams illuminates the region in the substrate beams after being illuminated by the first pair of light beams.

17. The HOE of claim 11 wherein the substrate comprises oppositely facing front and back surfaces, wherein each beam of the first and second pair of beams defines an angle measured with respect to a line normal to the front surface, and wherein each of the angles is different from each other.

18. The HOE of claim 11 wherein the substrate comprises:
a monomer dipentaerythritol hydroxypentaacrylate;
a liquid crystal;
a cross-linking monomer;
a coinitiator; and
a photoinitiator dye.

19. The HOE of claim 11 wherein the substrate comprises before illumination by the first and second pairs of light beams:
a polymerizable monomer;
a liquid crystal;
a cross-linking monomer;
a coinitiator; and
a photoinitiator dye.

20. The HOE of claim 11 wherein each beam of the first pair of light beams comprises light with wavelengths in a first bandwidth, and wherein each beam of the second pair of light beams comprises light with wavelengths in a second bandwidth, wherein the first bandwidth is different from the second bandwidth.

21. An optical element comprising a substrate with diffraction gratings recorded therein, the diffraction gratings being formed by illuminating the substrate with first and second pairs of light beams, wherein each of the first pair of light beams comprises light of a first wavelength, wherein each of the second pair of light beams comprises light of a second wavelength, wherein first diffraction gratings are produced in the substrate in response the substrate being illuminated with the first pair of light beams, wherein second diffraction gratings are produced in the substrate in response the substrate being illuminated with the second pair of light beams, and wherein the diffraction gratings represent a superimposition of the first and second diffraction gratings.
